(19) United States
(12) Patent Application Publication
(10) Pub. No.: US 2017/0028936 A1
(43) Pub. Date: Feb. 2, 2017

(54) VEHICLE-MOUNTED CAMERA CASE AND VEHICLE-MOUNTED CAMERA DEVICE

(71) Applicant: DENSO CORPORATION, Aichi (JP)

(72) Inventor: Muneaki Matsumoto, Kariya-city (JP)

(21) Appl. No.: 15/039,009

(22) PCT Filed: Nov. 11, 2014
(86) PCT No.: PCT/JP2014/005665

§ 371 Date: May 24, 2016

(30) Foreign Application Priority Data
Nov. 26, 2013 (JP) 2013-244288

(51) Int. Cl. B60R 11/04

(52) U.S. Cl. CPC B60R 11/04; B60R 2011/004

(57) ABSTRACT

A vehicle-mounted camera case mounted on an outer surface of a vehicle to house a camera is provided. The vehicle-mounted camera case includes an air inlet, an air outlet, and a shield. The air inlet takes air into the vehicle-mounted camera case when the vehicle moves forward. The air outlet discharges the air taken in from the air inlet and is formed in at least a lower portion of a rear end face of the vehicle-mounted camera case. The shield protrudes downward from an upper portion of the vehicle-mounted camera case.

### CROSS REFERENCE TO RELATED APPLICATION

This application is based on Japanese Patent Application No. 2013-244288 filed on Nov. 26, 2013, the disclosure of which is incorporated herein by reference.

### TECHNICAL FIELD

The present disclosure relates to a vehicle-mounted camera case and to a vehicle-mounted camera device provided with the vehicle-mounted camera case.

### BACKGROUND ART

There is a widely known device that uses a vehicle-mounted camera to capture an image representing a rear or side view from a vehicle and displays the captured image on a monitor in the vehicle. When such a device is used, each of the cameras is housed in a case and mounted on the roof of the vehicle or other external surface of the vehicle as described, for example, in Patent Literatures 1 and 2.

The case described in Patent Literature 1 has a transparent window. The window is located above the lens of the camera. The camera is entirely covered by the case. The case described in Patent Literature 2 has an air inlet and an air outlet. The air inlet is open to the front of the vehicle. The air outlet allows air taken in from the air inlet to blow out from around the camera. As air blows out from around the camera, dust, dirt, and other materials scattered from the road surface during the movement of the vehicle are prevented from adhering to the lens of the camera.

### PRIOR ART LITERATURE

### Patent Literatures

Patent Literature 1: JP 4519957B

Patent Literature 2: JP H8-113082A

### SUMMARY OF INVENTION

According to studies conducted by the inventor of the present application, because the air inlet of the case described in Patent Literature 2 is open vertically toward the front of the vehicle, raindrops may enter the case through the air inlet in rainy weather. The raindrops entering into the case through the air inlet are carried toward the camera together with air. The air taken in from the air inlet is discharged from the air outlet, which is formed around the surface of the lens. Therefore, the raindrops carried by the air may adhere to the lens. When the raindrops adhere to the lens, the visibility of the captured image becomes inadequate.

The case described in Patent Literature 1 covers the entire camera and is not provided with an opening that takes in air. Therefore, the raindrops are supposed not to enter the case through an opening and not to adhere to the lens. However, dust, dirt, and other materials scattered during the movement of the vehicle may adhere to the window of the case, making the visibility inadequate.

The present disclosure has been made in view of the above circumstances and has an object to provide a vehicle-mounted camera case and a vehicle-mounted camera that are capable of preventing the visibility from becoming inadequate due, for instance, to dust, dirt, and raindrops.

A vehicle-mounted camera case in an aspect of the present disclosure is mounted on an outer surface of a vehicle to house a camera. The vehicle-mounted camera case includes an air inlet, an air outlet, and a shield. The air inlet takes air into the vehicle-mounted camera case when the vehicle moves forward. The air outlet discharges the air taken in from the air inlet and is formed in at least a lower portion of a rear end face of the vehicle-mounted camera case and discharges the air taken in from the air inlet. The shield protrudes downward from an upper portion of the vehicle-mounted camera case.

When the vehicle moves forward, air is taken into the vehicle-mounted camera case through the air inlet and discharged from the air outlet. The air outlet is formed in the lower portion of the rear end face of the vehicle-mounted camera case. When the camera is housed in the vehicle-mounted camera case, the camera is positioned above the air outlet.

When the vehicle moves, dust, dirt, and other materials are occasionally scattered from the road surface. The scattered materials, such as dust and dirt, are blocked by the air discharged from the air outlet and unlikely to reach the lens of the camera, which is positioned above the air outlet. This inhibits the dust, dirt, and other materials, which are scattered from the road surface, from adhering to the lens of the camera.

Further, even if raindrops enter the vehicle-mounted camera case through the air inlet, the raindrops are blocked by the shield, which protrudes downward from the upper portion of the vehicle-mounted camera case. Thus, as far as the camera is disposed in the vehicle-mounted camera case in such a manner that the lens of the camera is positioned closer to the rear end face of the vehicle-mounted camera case than the shield, it is possible to inhibit the raindrops from falling down from above the lens and adhering to the lens.

Furthermore, when the vehicle moves forward, the air taken in from the air inlet is discharged from the air outlet. The camera housed in the vehicle-mounted camera case is then air-cooled. This suppresses an increase in the temperature of the camera.

A vehicle-mounted camera device in an aspect of the present disclosure includes a vehicle-mounted camera case and a camera. The vehicle-mounted camera case is mounted on an outer surface of a vehicle. The camera is housed in the vehicle-mounted camera case. The vehicle-mounted camera case includes an air inlet and an air outlet. The air inlet takes air into the vehicle-mounted camera case when the vehicle moves forward. The air outlet discharges the air taken in from the air inlet and is formed in at least a lower portion of the rear end face of the vehicle-mounted camera case. At least part of the space between the vehicle-mounted camera case and the camera is blocked, the part being closer to the air outlet than to the air inlet.

When the vehicle moves forward, air is taken into the vehicle-mounted camera case through the air inlet and discharged from the air outlet. The air outlet is formed below the lower surface of the camera. That is, the camera is positioned above the air outlet.

When the vehicle moves, dust, dirt, and other materials are occasionally scattered from the road surface. The scattered materials, such as dust and dirt, are blocked by the air discharged from the air outlet and unlikely to reach the lens of the camera, which is positioned above the air outlet. This inhibits the dust, dirt, and other material, which are scattered from the road surface, from adhering to the lens of the camera.

Further, even if raindrops enter the vehicle-mounted camera case through the air inlet, the raindrops are inhibited from passing above the camera to reach the lens because at least a part of the space between the vehicle-mounted camera case and the upper surface of the camera is blocked. This makes it possible to inhibit the raindrops from falling down from the top of the lens and adhering to the lens.

Furthermore, when the vehicle moves forward, the air taken in from the air inlet is discharged from the air outlet. The camera housed in the vehicle-mounted camera case is then air-cooled. This suppresses an increase in the temperature of the camera.

### BRIEF DESCRIPTION OF DRAWINGS

FIG. 1 is a side view of a vehicle-mounted camera device according to a first embodiment;

FIG. 2 is a view taken in the direction of arrow II in FIG. 1;

FIG. 3 is a cross-sectional view taken along line III-III in FIG. 2;

FIG. 4 is a perspective view of a vehicle-mounted camera device according to a second embodiment;

FIG. 5 is a cross-sectional view of a vehicle-mounted camera device according to a third embodiment;

FIG. 6 is a cross-sectional view of a vehicle-mounted camera case according to a fourth embodiment;

FIG. 7 is a rear view of a vehicle-mounted camera device according to a fifth embodiment;

FIG. 8 is a rear view of a vehicle-mounted camera device according to a sixth embodiment; and

FIG. 9 is a cross-sectional view taken along line IX-IX in FIG. 8.

### DESCRIPTION OF EMBODIMENTS

### First Embodiment

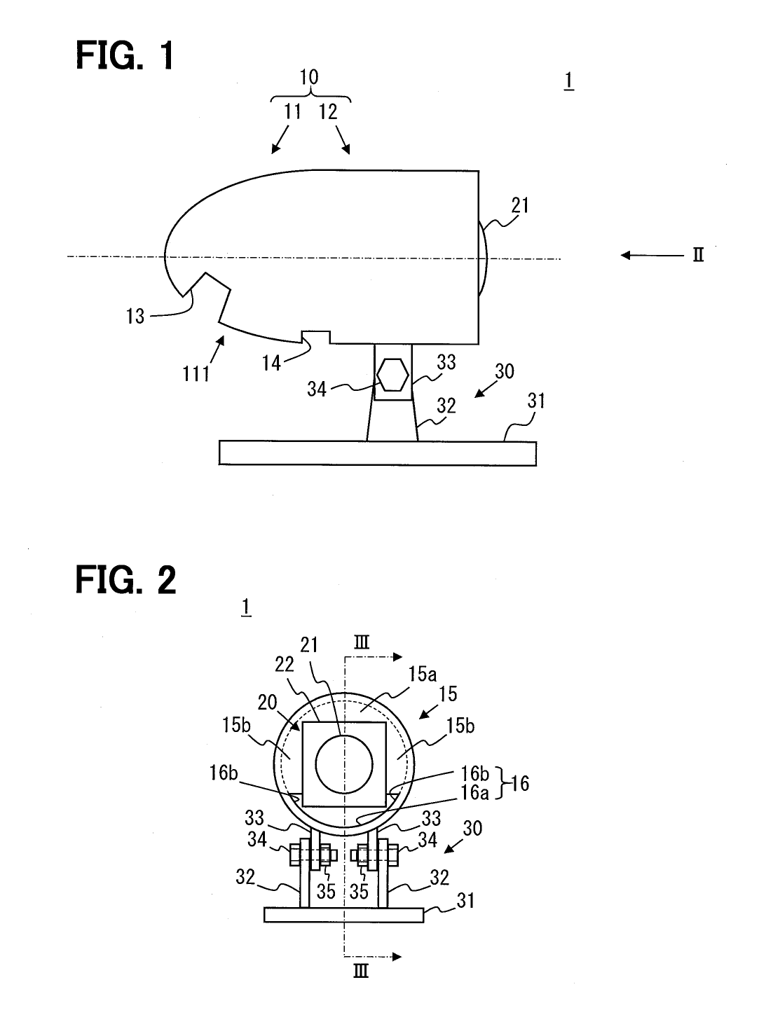

Embodiments of the present disclosure will now be described with reference to the accompanying drawings. As illustrated in FIGS. 1 and 2, a vehicle-mounted camera device 1 according to a first embodiment includes a vehicle-mounted camera case (hereinafter simply referred to as the camera case) 10 having a cannon-shell-shape. The surface of the camera case 10 is coated with publicly known heat-proof paint such as acrylic resin paint with ceramic beads.

### Configuration of Vehicle-Mounted Camera Device 1

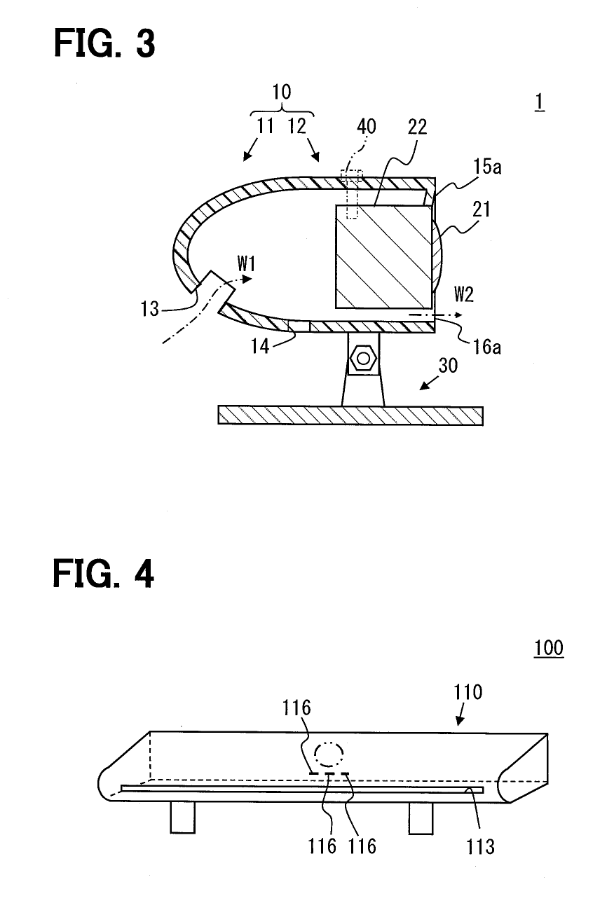

As illustrated in FIG. 3, a front portion 11 of the camera case 10 is open toward a rear portion 12 and a cross-section of the front portion 11 taken along a plane containing a central axis has substantially a U shape. The rear portion 12 is cylindrical and has the same diameter as the rear end of the front portion 11.

As mentioned above, the cross-section of the front portion 11 taken along the plane containing the central axis (and running parallel to the central axis) is substantially shaped like the letter U. Therefore, of the front portion 11, a portion below the central axis, which is illustrated in FIG. 1 by a one-dot chain line, is a downwardly-inclined wall portion 111, which is inclined downward in a rearward direction. More specifically, as illustrated in FIG. 1, the angle between the downwardly-inclined wall portion 111 and the central axis decreases in a rearward direction. The downwardly-inclined wall portion 111 is not limited to the one having a substantially U-shaped cross-section as mentioned above. The downwardly-inclined wall portion 111 is downwardly inclined toward the rear of the camera case. For example, the downwardly-inclined wall portion 111 may be shaped so that its cross-section taken along a plane perpendicular to the central axis increases in a rearward direction. An air inlet 13 is formed in such a manner as to penetrate the downwardly-inclined wall portion 111. As the air inlet 13 is formed in the downwardly-inclined wall portion 111, the air inlet 13 is open toward the lower half of the camera case 10 at such an angle that the air inlet 13 is visible from the front of the vehicle-mounted camera device 1.

Meanwhile, a water drain hole 14 is formed in the bottom of the rear portion 12 in such a manner as to penetrate the camera case 10. As the air inlet 13 is formed in the front portion 11, the water drain hole 14 formed in the camera case 10 is positioned rearward of the air inlet 13.

The camera case 10 houses a camera 20 (see FIGS. 2 and 3). The camera 20 includes a lens 21, which is illustrated in FIG. 1 as well as in FIGS. 2 and 3.

A mounting device 30 is secured to the rear portion 12. The mounting device 30 is used to mount the camera case 10 on a vehicle (not shown). The mounting device 30 includes a base 31, a base protrusion 32, a case retainer 33, a bolt 34, and a nut 35 (see FIG. 2).

The base 31 is shaped like a flat plate and secured to the outer surface of the vehicle (not shown), b, for example, adhesive, welding, or bolts. The base 31 is secured, that is, the vehicle-mounted camera device 1 is secured, for example, to the upper or lower surface of the rear end of a roof, a rear bumper, a trunk lid, or a side view mirror so that the camera 20 can capture an image representing a rear or side view from the vehicle.

The base protrusion 32 is secured to the base 31 and protruded from one surface of the base 31. One end of the case retainer 33 is coupled to the leading end of the base protrusion 32 with the bolt 34 and the nut 35. The other end of the case retainer 33 is secured to the lower surface of the rear portion 12 of the camera case 10. The mounting device 30 fastens the vehicle-mounted camera device 1 to the vehicle in such a manner that the front portion 11 of the camera case 10 faces forward of the vehicle.

As illustrated in FIG. 2, the camera 20 housed in the camera case 10 includes a lens 21 and a camera main body 22. As illustrated in FIGS. 2 and 3, the camera main body 22 is shaped like a rectangular parallelepiped. The lens 21 is disposed at the center of the rear surface of the camera main body 22.

The camera 20 can be secured to the camera case 10 by various publicly known methods. For example, as indicated in FIG. 3 by a two-dot chain line, the camera 20 may be secured to the camera case 10 by using a bolt 40 that penetrates the camera case 10 to engage with the camera 20.

As illustrated in FIG. 2, a shield 15 is formed on the camera case 10. The shield 15 includes an upper shield 15a and a pair of lateral shields 15b. The upper shield 15a protrudes downwardly from an upper portion of the camera case 10. The lateral shields 15b protrude toward the camera main body 22 from the sides of the camera case 10.

As illustrated in FIG. 3, the upper shield 15a is formed on the rear end of the rear portion 12 of the camera case 10. Although not shown in FIG. 3, the lateral shields 15b are also formed on the rear end of the rear portion 12 of the camera case 10 with respect to the front-rear direction of the camera case 10, as is the case with the upper shield 15a.

The upper shield 15a and the lateral shields 15b have a flat front end face. Further, as the camera main body 22 is substantially shaped like a rectangular parallelepiped, its upper and lateral surfaces are flat. The front end face of the upper shield 15a and the front end faces of the lateral shields 15b are in contact respectively with the flat upper and lateral surfaces of the camera main body 22. They are brought into contact with each other in order to prevent raindrops from passing between the camera main body 22 and the upper and lateral shields 15a, 15b.

Further, the longitudinal (left-right direction in FIG. 2) length of the upper shield 15a is greater than the widthwise length of the upper surface of the camera main body 22, and the upper shield 15a is in contact with the whole width of the upper surface of the camera main body 22. Meanwhile, the up-down direction range of the lateral shields 15b is from the upper surface of the camera main body 22 to the lower end of the lens 21. On the sides of the camera main body 22, there is a space between the lower end of the lens 21 and the lower surface of the camera main body 22. This space is a lateral air outlet 16b, which is a part of an air outlet 16.

The air outlet 16 includes the lateral air outlet 16b and a lower air outlet 16a. The lower air outlet 16a is formed between the lower surface of the camera main body 22 and the camera case 10. The air outlet 16 has a smaller opening area than the air inlet 13.

### Operational Advantages of Vehicle-Mounted Camera Device 1

When the vehicle with the vehicle-mounted camera device 1 having the above-described configuration moves forward, air is taken into the camera case 10 through the air inlet 13 as indicated by arrow W1 in FIG. 3. The air taken in is then discharged from the lower air outlet 16a as indicated by arrow W2. As is obvious from FIG. 3, the lower surface of the camera main body 22 is parallel to a portion of the camera case 10 that opposes the lower surface of the camera main body 22. Therefore, the air discharged from the lower air outlet 16a is in parallel to the lower surface of the camera main body 22. Further, although not shown in FIG. 3, the air is also discharged from the lateral air outlet 16b.

The lower air outlet 16a is formed in the rear end face of the camera case 10 and positioned below the lower surface of the camera 20. Specifically, the camera 20 is positioned above the lower air outlet 16a.

When the vehicle moves, dust, dirt, and other materials on the road surface are occasionally scattered. The scattered materials, such as dust and dirt, are blocked by the air discharged from the lower air outlet 16a and unlikely to reach the lens 21 of the camera 20, which is positioned above the lower air outlet 16a. Further, the air discharged from the lateral air outlet 16b also blocks the dust, dirt, and other materials from reaching the lens 21 even when they are scattered from the road surface. As a result, dust, dirt, and other materials scattered from the road surface can be inhibited from adhering to the lens 21 of the camera 20.

Further, even if raindrops enter the camera case 10 through the air inlet 13, the raindrops are inhibited from passing above the camera main body 22 to reach the lens 21 of the camera main body 22 because the space between the camera case 10 and the upper surface of the camera main body 22 is blocked by the upper shield 15a. This makes it possible to inhibit the raindrops from falling down from above the lens 21 and adhering to the lens 21.

Furthermore, a portion above the lower end of the lens 21 that is included in the space between the camera case 10 and a lateral surface of the camera main body 22 is blocked by the lateral shields 15b. Therefore, the raindrops are inhibited from passing the sides of the camera main body 22 and reaching the surface of the lens 21 of the camera main body 22. This makes it possible to inhibit the raindrops from gushing out from the sides of the lens 21 and adhering to the lens 21.

It is conceivable that the raindrops may gush out from the lower air outlet 16a and the lateral air outlet 16b. However, the lower air outlet 16a and the lateral air outlet 16b are positioned below the lens 21. Therefore, even when the raindrops gush out from the lower air outlet 16a and the lateral air outlet 16b, the raindrops are less likely to adhere to the lens 21 than when the raindrops gush out from a portion above the lower end of the lens 21.

Further, the air outlet 16 has a smaller opening area than the air inlet 13. This results in an increase in the flow rate of air discharged from the air outlet 16. Consequently, it is possible to particularly inhibit dust, dirt, and other materials scattered from the road surface from reaching the lens 21.

Furthermore, the air inlet 13 is formed in the downwardly-inclined wall portion 111. Therefore, even in rainy weather, it is possible to inhibit raindrops from entering the camera case 10 through the air inlet 13.

Moreover, raindrops entering the camera case 10 through the air inlet 13 can be discharged from the water drain hole 14. This also makes it possible to inhibit the raindrops from gushing out from the air outlet 16 and adhering to the lens 21.

Additionally, when the vehicle moves forward, the air taken in from the air inlet 13 is discharged from the air outlet 16. The camera 20 housed in the camera case 10 is then air-cooled. This suppresses an increase in the temperature of the camera 20.

In addition, the surface of the camera case 10 is coated with heat-proof paint. This also suppresses an increase in the temperature of the camera 20.

### Second Embodiment

A second embodiment will now be described. In the description of the second and subsequent embodiments, elements designated by the same reference numerals as the elements described in conjunction with foregoing embodiments are identical with the corresponding elements unless otherwise specifically stated. Further, when only a specific portion of the configuration is described, the foregoing embodiments are applicable to the other portion of the configuration.

As illustrated in FIG. 4, a camera case 110 included in a vehicle-mounted camera device 100 according to the second embodiment is capable of functioning as a spoiler and secured to a trunk lid. An air inlet 113 is formed in the front end face of the camera case 110.

The camera 20 is omitted from FIG. 4. However, the position at which the camera 20 is mounted is indicated by a two-dot chain line circle. As is obvious from the position of the circle, the camera 20 is disposed at the longitudinal center of the camera case 110. Three horizontally-long air outlets 116 are formed below the camera 20. Except for a portion in which the air outlets 116 are formed and a portion on which the camera 20 is disposed, the rear end face of the camera case 110 is covered.

As described in conjunction with the second embodiment, the camera case 110 may have a shape that is long in the direction of vehicle width. Further, in the second embodiment, too, the air outlets 116 have a smaller opening area than the air inlet 113. The ratio of the opening area of the air outlets 116 to the opening area of the air inlet 113 is smaller than in the first embodiment. Therefore, the flow rate of air discharged from the air outlets 116 is higher than in the first embodiment.

It is assumed that no shield is used in the second embodiment. Alternatively, however, the second embodiment may include the same upper shield 15a as the first embodiment. Another alternative is to include a shield 215 that is used in a subsequently described third embodiment.

### Third Embodiment

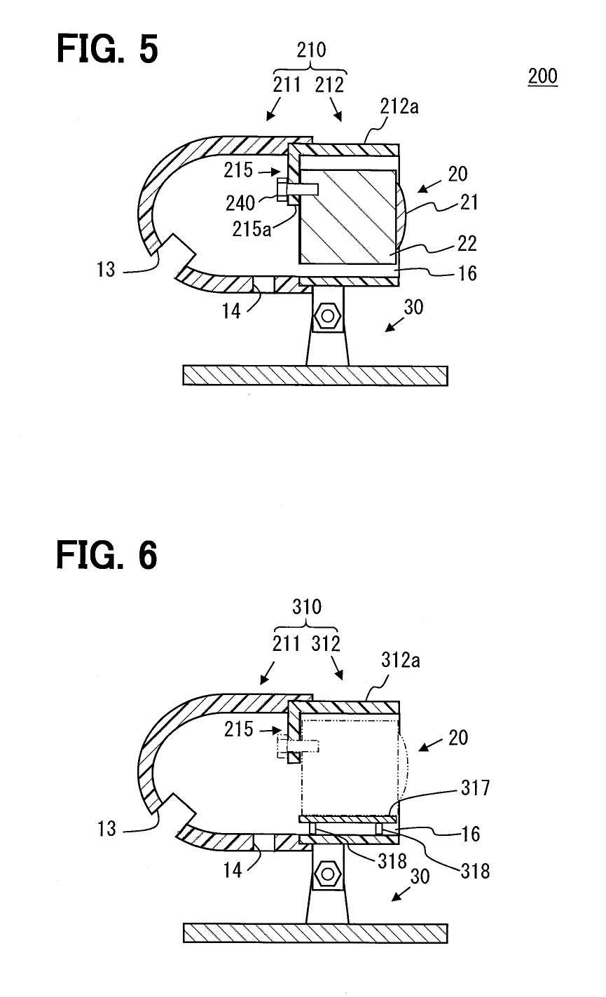

As illustrated in FIG. 5, a camera case 210 included in a vehicle-mounted camera device 200 according to a third embodiment is formed of a front casing member 211 and a rear casing member 212. The inside diameter of the open end of the front casing member 211 is substantially equal to the outside diameter of the rear casing member 212. The camera case 210 is formed by fitting the open end of the front casing member 211 onto the front end of the rear casing member 212. As is the case with the first embodiment, the air inlet 13 is formed in the front casing member 211. The water drain hole 14 is also formed in the front casing member 211.

The rear casing member 212 includes a cylindrical portion 212a and a shield 215. The shield 215 is disposed at the front end of the cylindrical portion 212a and protruded downward from an upper portion of the cylindrical portion 212a. Although not shown in FIG. 5, the lower surface 215a of the shield 215 is formed between one end of the cylindrical portion 212a and the other as viewed in a cross-section perpendicular to the axis of the cylindrical portion 212a.

In the third embodiment, the camera 20 is secured to the shield 215 by using the bolt 40. In this state, the same air outlet 16 as in the first embodiment is formed between the camera main body 22 and the cylindrical portion 212a of the rear casing member 212. The shield 215 is formed closer to the air inlet 13 than to the camera 20 and closer to the air outlet 16 than to the air inlet 13.

In the third embodiment, the shield 215 blocks the raindrops, which have entered the camera case 210 through air inlet 13, from moving toward the lens 21. The shield 215 also functions as a retainer that secures the camera 20. Therefore, the camera case 210 need not particularly be shaped so as to secure the camera 20 as far as the shield 215 exists.

### Fourth Embodiment

As illustrated in FIG. 6, a fourth embodiment relates to only a camera case 310. For the sake of explanation, however, the camera 20 is also indicated by a two-dot chain line.

The camera case 310 is similar in configuration to the camera case 210 according to the third embodiment. The camera case 310 according to the fourth embodiment merely differs from the camera case 210 according to the third embodiment in that a rear casing member 312 includes a camera mount 317 and a coupler 318.

The camera mount 317 is shaped like a flat plate. The camera 20 is mounted on the camera amount 317 as indicated by the two-dot chain line.

The camera mount 317 is secured to a cylindrical portion 312a via the columnar coupler 318. This results in the formation of the air outlet 16 between the camera mount 317 and the cylindrical portion 312a.

### Fifth Embodiment

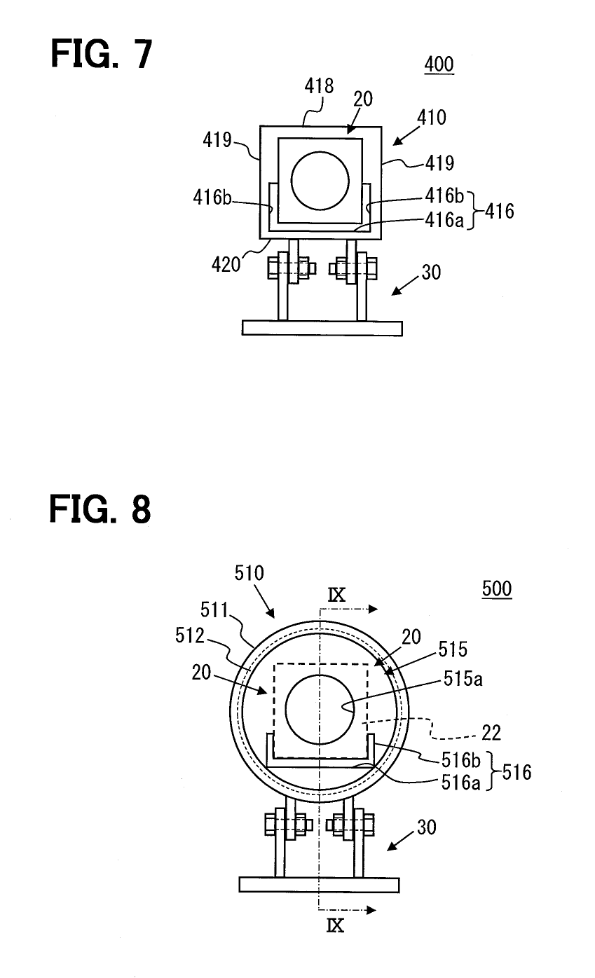

As illustrated in FIG. 7, the rear end face of a camera case 410 included in a vehicle-mounted camera device 400 according to a fifth embodiment is shaped like a square. The camera case 410 includes an upper wall portion 418, a side wall portion 419, and a lower wall portion 420, which are shaped like a flat plate.

The camera 20 is secured to the camera case 410 while the upper surface of the camera 20 is in contact with the inner surface of the upper wall portion 418, that is, in contact with the inner upper surface of the camera case 410. This blocks the space between the camera case 410 and the upper surface of the camera 20.

Although not shown in FIG. 7, an air inlet is also formed in the front of the camera case 410 according to the fifth embodiment. Air taken into the camera case 410 through the air inlet is discharged from an air outlet 416.

The air outlet 416 includes a lower air outlet 416a and a lateral air outlet 416b. The lower air outlet 416a is formed between the lower surface of the camera 20 and the lower wall portion 420. The lateral air outlet 416b is formed partially between a lateral surface of the camera 20 and the side wall portion 419.

### Sixth Embodiment

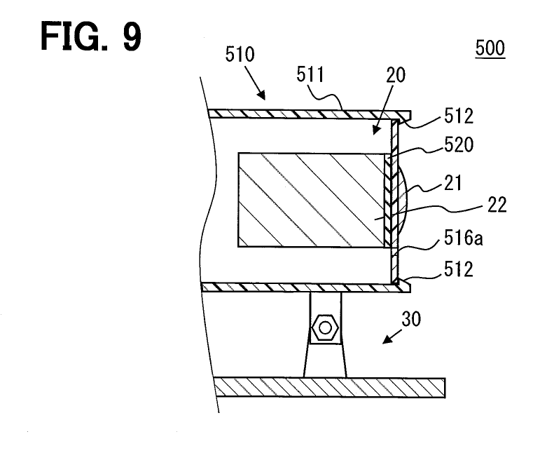

FIGS. 8 and 9 illustrate a vehicle-mounted camera device 500 according to a sixth embodiment. The camera 20 is housed in a camera case 510. An inward-protruding circular protrusion 512 is formed on an end of a cylindrical portion 511 of the camera case 510 that is positioned toward the lens 21.

A shielding plate 515, which corresponds to the shield, is shaped like a circular plate. The outer peripheral surface of the shielding plate 515 is in contact with the inner peripheral surface of the cylindrical portion 511, and one lateral surface of the shielding plate 515 is in contact with the circular protrusion 512.

An opening 515a is formed in the shielding plate 515. The opening 515a has substantially the same diameter as the lens 21, and the lens 21 protrudes from the opening 515a. A lateral surface of the shielding plate 515 that is not in contact with the circular protrusion 512 is in contact with a rubber plate 520, which is an elastic plate member. The rubber plate 520 has an opening for the lens 21 and is attached to an end face of the camera main body 22.

The shielding plate 515 is locked in its position as its one lateral surface is in contact with the rubber plate 520, which is attached to the end face of the camera main body 22, and the other lateral surface is in contact with the circular protrusion 512. Alternatively, however, the end face of the camera main body 22 may be brought into contact with the shielding plate 515 without incorporating the rubber plate 520.

Further, an air outlet 516 is formed in the shielding plate 515. The air outlet 516 includes a lower air outlet 516a and a pair of lateral air outlets 516b. The lower air outlet 516a is shaped like a rectangle parallel to the lower surface of the camera main body 22. The position of the upper side of the lower air outlet 516a substantially coincides with the position of the lower surface of the camera main body 22. The lateral air outlets 516b are shaped like a rectangle parallel to the lateral surfaces of the camera main body 22 and coupled to both ends of the lower air outlet 516a. The upper ends of the lateral air outlets 516b substantially coincide with the lower end of the lens 21.

Although not shown in FIG. 9, the sixth embodiment is also configured so that an air inlet is formed in the front of the camera case 510. Air taken into the camera case 510 through the air inlet is discharged from the air outlet 516.

Further, the rubber plate 520 is positioned between the end face of the camera main body 22 and the shielding plate 515. Thus, a gap is unlikely to be formed between the end face of the camera main body 22 and the shielding plate 515. This inhibits air and raindrops from being discharged through a gap between the shielding plate 515 and the lens 21.

While embodiments of the present disclosure have been exemplified, embodiments according to the present disclosure are not limited to those described above. For example, modifications described below are also within the scope of the present disclosure. Further, it is to be understood that various other modifications can be made without departing from the spirit of the present disclosure.

### First Modification

It is assumed in the first embodiment that the water drain hole 14 is formed in the bottom of the camera case 10. However, the water drain hole 14 need not always be formed in the bottom. The water drain hole 14 may be formed in any region as far as it is in the lower half of the camera case 10.

### Second Modification

Further, it is assumed in the first embodiment that the upper shield 15a is formed on the whole portion of the camera case 10 that is positioned above the camera 20. Alternatively, however, the upper shield 15a may be formed only on a limited portion of the camera case 10 that is positioned above the camera 20.

The present disclosure is not limited to the foregoing embodiments, and the foregoing embodiments may be variously modified. The scope of the present disclosure also includes an embodiment that is obtained by appropriately combining technical elements disclosed in different embodiments.

1. A vehicle-mounted camera case mounted on an outer surface of a vehicle to house a camera, the vehicle-mounted camera case comprising:
an air inlet for taking air into the vehicle-mounted camera case when the vehicle moves forward;
an air outlet for discharging the air taken in from the air inlet, wherein the air outlet is formed in at least a lower portion of a rear end face of the vehicle-mounted camera case; and
a shield that protrudes downward from an upper portion of the vehicle-mounted camera case.

2. The vehicle-mounted camera case according to claim 1, further comprising:
a water drain hole that is formed in a lower portion of the vehicle-mounted camera case in such a manner as to penetrate the vehicle-mounted camera case.

3. The vehicle-mounted camera case according to claim 1, wherein
the air outlet has a smaller opening area than the air inlet.

4. The vehicle-mounted camera case according to claim 1, further comprising:
a downwardly-inclined wall portion that is disposed on a front portion of the vehicle-mounted camera case;
wherein:
the downwardly-inclined wall portion is downwardly inclined toward a rear of the vehicle-mounted camera case; and
the air inlet is formed in the downwardly-inclined wall portion.

5. The vehicle-mounted camera case according to claim 1, wherein
the outer surface of the vehicle-mounted camera case is coated with heat-proof paint.

6. A vehicle-mounted camera device comprising:
a vehicle-mounted camera case that is mounted on the outer surface of a vehicle; and
a camera that is housed in the vehicle-mounted camera case;
wherein the vehicle-mounted camera case includes
an air inlet for taking air into the vehicle-mounted camera case when the vehicle moves forward, and
an air outlet for discharging the air taken in from the air inlet, wherein a lower portion of a rear end face of the vehicle-mounted camera case defines the air outlet,
wherein at least part of a space between the vehicle-mounted camera case and an upper surface of the camera is blocked, the part of the space being positioned closer to the air outlet than to the air inlet.

7. The vehicle-mounted camera device according to claim 6, further comprising:
a shield that protrudes downward from an upper portion of the vehicle-mounted camera case at a position closer to the air outlet than to the air inlet and blocks the at least part of the space between the vehicle-mounted camera case and the upper surface of the camera.

8. The vehicle-mounted camera device according to claim 7, wherein the camera is secured to the shield.

9. The vehicle-mounted camera device according to claim 6, wherein
the space between the vehicle-mounted camera case and the upper surface of the camera is blocked by securing the camera to the vehicle-mounted camera case with the upper surface of the camera brought into contact with the inner upper surface of the vehicle-mounted camera case.
